(19) United States
(12) Patent Application Publication
(10) Pub. No.: US 2025/0318980 A1
(43) Pub. Date: Oct. 16, 2025

(54) SLIDING MASSAGE DEVICE AND MASSAGER

(71) Applicant: Yijingxin (Shandong) Medical Device Technology Co., Ltd., Ji’ning (CN)

(72) Inventor: Lei YU, Ji’ning (CN)

(73) Assignee: Yijingxin (Shandong) Medical Device Technology Co., Ltd., Ji’ning (CN)

(21) Appl. No.: 19/177,371

(22) Filed: Apr. 11, 2025

(30) Foreign Application Priority Data
Apr. 11, 2024 (CN) 202420744008.8

(51) Int. Cl. A61H 7/00; A61H 19/00; A61H 23/02

(52) U.S. Cl. CPC A61H 7/004; A61H 19/00; A61H 23/0263; A61H 2201/1215; A61H 2201/149; A61H 2201/1692

(57) ABSTRACT

The present invention discloses a sliding massage device and massager comprising a drive motor, drive shaft, rotating frame, support housing, and sliding ring. The rotating frame includes a sliding block fixed to the sliding ring and has an inward-recessed drive guide rail for the sliding block. The support housing contains the rotating frame in an accommodation cavity and features a limit guide rail allowing the sliding block to protrude outside. A vibration assembly is mounted on the housing opposite the motor side. During rotation, the sliding block moves along the drive guide rail, causing the sliding ring to move vertically relative to the housing. This innovative structure enables diversified massage motions while maintaining comfort. The present invention provides users with enhanced massage techniques and improved user experience through its unique sliding mechanism combined with vibration functionality.

### CROSS-REFERENCE TO RELATED APPLICATIONS

The application claims priority to Chinese patent application No. 202420744008.8, filed on Apr. 11, 2024, the entire contents of which are incorporated herein by reference.

### TECHNICAL FIELD

The present invention belongs to the technical field of massage products, and more specifically, relates to a sliding massage device and massager.

### BACKGROUND

With the improvement of people's living standards, more and more people choose massagers to relieve physical fatigue. Massagers are a new generation of health equipment developed based on physics, bionics, bioelectricity, traditional Chinese medicine, and years of clinical practice. They can relax muscles, soothe nerves, promote blood circulation, enhance cell metabolism, improve skin elasticity, relieve fatigue, significantly reduce various chronic pain, acute pain, and muscle soreness, relax the body to reduce stress, and reduce skin wrinkles. Currently, the market offers a wide variety of devices for human massage with comprehensive functions. Massage beds alone include rolling massage, vibration massage, far-infrared heating massage, magnetic therapy massage, and other functions, allowing people to enjoy the comfort and pleasure of massage after stressful work.

Vibration massagers are among the most common types of massagers, with the main feature of generating high-frequency vibrations to massage the human body and relieve physical fatigue. Due to irregularities in female sexual life, which have affected personal and family harmony and happiness to varying degrees, sexual function auxiliary massagers for women on the market can compensate for these shortcomings and bring more pleasure to life. However, the functions of sexual function auxiliary massagers in the prior art are relatively singular, only able to meet user needs by changing the shape, vibration frequency, and vibration mode of the massager, resulting in a singular experience and failing to provide users with a better user experience.

### SUMMARY

The purpose of the present invention is to provide a sliding massage device to solve the technical problem in the prior art where the functions of massagers are relatively singular, only able to meet user needs by changing the shape, vibration frequency, and vibration mode of the massager, resulting in a singular experience and failing to provide users with a better user experience.

To achieve the above purpose, the technical solution adopted by the present invention is as follows: A sliding massage device for a massager is provided, comprising: a drive motor; a drive shaft fixedly connected to the output shaft of the drive motor; a rotating frame sleeved on and fixedly connected to the surface of the drive shaft; a support housing sleeved around the periphery of the rotating frame and rotatably connected to the drive shaft; and a sliding ring sleeved on the support housing and slidably connected to the rotating frame; the rotating frame is slidably provided with a sliding block fixedly connected to the sliding ring, and the surface of the rotating frame is recessed inward to form a drive guide rail for slidably connecting the sliding block; the support housing has an accommodation cavity for housing the rotating frame, and the support housing is provided with a limit guide rail penetrating through it to allow the sliding block to extend outside the accommodation cavity, with a vibration assembly arranged on the side of the support housing opposite to the side facing the drive motor; when the rotating frame rotates, the sliding block slides along the drive guide rail and drives the sliding ring to move vertically relative to the support housing.

In one embodiment, the opposite side surfaces of the sliding block are inwardly recessed to form limit grooves for accommodating the side walls of the support housing located on both sides of the limit guide rail.

In one embodiment, there are multiple sliding rings, which are spaced apart and sleeved on the support housing and slidably connected to the rotating frame.

In one embodiment, the outer surface of the sliding ring is uniformly provided with multiple massage protrusions.

In one embodiment, the vibration assembly includes a mounting housing fixedly connected to the support housing and a vibration motor disposed within the mounting housing.

In one embodiment, the sliding massage device further includes a bent rotating shaft, one end of which is fixedly connected to the drive shaft and the other end is fixedly connected to the vibration assembly.

In one embodiment, the sliding massage device further includes an eccentric transmission assembly and an activity assembly disposed between the support housing and the vibration assembly. The eccentric transmission assembly includes a support frame fixedly connected to the support housing, an eccentric wheel fixedly connected to the drive shaft, and a transmission rod fixedly connected to the eccentric wheel. The activity assembly includes a moving frame rotatably disposed on the support frame and a swing arm disposed on the moving frame. The transmission rod is slidably connected to the moving frame, and the swing arm is fixedly connected to the vibration assembly.

In one embodiment, one end of the transmission rod is provided with a fixed part fixedly connected to the eccentric wheel, and the other end is provided with a sliding part slidably connected to the moving frame. The moving frame is provided with a slide rail for slidably connecting with the transmission rod, and the sliding part is penetrated with a connection hole for the slide rail to pass through.

In one embodiment, the support frame includes a support base fixedly connected to the support housing, two support arms disposed on opposite sides of the support base, and a connecting shaft connecting the two support arms. Both support arms are penetrated with first fixing holes for installing the connecting shaft, and the moving frame is penetrated with a second fixing hole for the connecting shaft to pass through.

The beneficial effects of the sliding massage device provided by the present invention are as follows: Compared with prior art, the sliding massage device of the present invention is used in a massager. The device comprises a drive motor, a drive shaft fixedly connected to the motor's output shaft, a rotating frame sleeved on and fixed to the drive shaft, a support housing enclosing the rotating frame and rotatably connected to the drive shaft, and a sliding ring sleeved on the support housing and slidably connected to the rotating frame. The rotating frame is slidably equipped with a sliding block fixed to the sliding ring, with its surface recessed to form a drive guide rail for the sliding block. The support housing has a cavity accommodating the rotating frame, with a limiting guide rail penetrating its wall to allow the sliding block to extend outside. A vibration assembly is disposed on the side of the support housing opposite to the drive motor. When the rotating frame rotates, the sliding block moves along the drive guide rail, driving the sliding ring to perform vertical reciprocating motion relative to the support housing. The drive motor provides kinetic energy: when activated, its output shaft transmits power to the drive shaft, rotating both the shaft and the fixed rotating frame. As the support housing encloses the rotating frame while being rotatably connected to the drive shaft and fixed to the motor, the sliding block extends through the housing's limiting guide rail to connect with the sliding ring. During rotation, constrained by the limiting guide rail, the sliding block slides along the drive guide rail, driving the sliding ring to reciprocate vertically. This motion, combined with the vibration assembly on the support housing, delivers massaging effects. Additionally, the support housing serves protective functions, preventing damage during transportation/use while ensuring structural rigidity. It maintains smooth contours of the massager, avoiding localized depressions during sliding ring movement to enhance user comfort. On the premise of ensuring the comfort of users, the sliding massage device can bring more diversified massage methods to users, meet their use needs and bring better use experience to users.

The purpose of the present invention is to provide a massager to solve the technical problem in the prior art where the functions of massagers are relatively singular, only able to meet user needs by changing the shape, vibration frequency, and vibration mode of the massager, resulting in a singular experience and failing to provide users with a better user experience.

To achieve the above purpose, the technical solution adopted by the present invention is to provide a massager comprising a silicone soft shell with an inner cavity and the aforementioned sliding massage device disposed within the silicone soft shell.

Compared with existing technologies, the massager of the present invention comprises a silicone soft shell with an internal cavity and the aforementioned sliding massage device installed inside. The silicone soft shell covering the outer surface of the sliding massage device offers dual benefits: firstly, it makes the massager's surface softer and more elastic, significantly improving user comfort during operation; secondly, it provides waterproof protection, facilitating easier use and cleaning while extending the product's service life. The sliding massage device operates using kinetic energy supplied by a drive motor. When activated, the motor's output shaft transmits power to the drive shaft, initiating rotation. This rotational motion is transferred to the rotating frame fixed to the drive shaft. The support housing encloses the rotating frame within its cavity while maintaining rotational connection with the drive shaft and fixed connection with the motor. A sliding block mounted on the rotating frame extends through the support housing's limit guide rail and connects firmly with the sliding ring. During operation, as the rotating frame turns, the sliding block moves along the drive guide rail under the constraint of the limit guide rail. This creates reciprocating vertical motion relative to the support housing, which drives the sliding ring (connected to the sliding block and surrounding the support housing) to move up and down repeatedly. This movement, combined with vibrations from the vibration assembly on the support housing, delivers effective massage therapy. The support housing serves multiple protective functions: it safeguards the sliding massage mechanism from compression damage during transportation and use; maintains the massager's structural integrity for a firm, flat appearance; and prevents localized depressions in the silicone shell during the sliding ring's vertical movement-all contributing to enhanced user comfort. On the premise of ensuring the comfort of users, the sliding massage device can bring more diversified massage methods to users, meet their use needs and bring better use experience to users.

### BRIEF DESCRIPTION OF DRAWINGS

To more clearly illustrate the technical solutions in the embodiments of the present invention, the following briefly introduces the accompanying drawings required for describing the embodiments or the prior art. Obviously, the accompanying drawings in the following description are only some embodiments of the present invention. For those of ordinary skill in the art, other drawings can be obtained based on these accompanying drawings without creative effort.

FIG. 1 is a front view structural diagram of the sliding massage device according to Embodiment 1 of the present invention;

FIG. 2 is an exploded structural diagram of the sliding massage device according to Embodiment 1 of the present invention;

FIG. 3 is a perspective structural diagram of the sliding massage device according to Embodiment 2 of the present invention;

FIG. 4 is a perspective structural diagram of the sliding massage device according to Embodiment 3 of the present invention.

Wherein, marks in the drawings:

1. Drive motor; 11. Drive shaft; 2. Rotating frame; 21. Sliding block; 211. Limit groove; 22. Drive guide rail; 3. Support housing; 31. Accommodation cavity; 32. Limit guide rail; 4. Sliding ring; 41. Massage protrusion; 5. Vibration assembly; 6. Bent rotating shaft; 7. Eccentric transmission assembly; 71. Support frame; 711. Support base; 712. Support arm; 713. Connecting shaft; 72. Eccentric wheel; 73. Transmission rod; 731. Sliding part; 8. Moving frame; 81. Slide rail.

### DETAILED DESCRIPTION OF THE EMBODIMENTS

To make the technical problems, solutions, and beneficial effects of the present invention clearer, the following provides a further detailed description of the present invention with reference to the accompanying drawings and embodiments. It should be understood that the specific embodiments described herein are only used to explain the present invention and not to limit it.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element.

It should be understood that the orientation or positional relationship indicated by terms such as “length”, “width”, “upper”, “lower”, “front”, “rear”, “left”, “right”, “vertical”, “horizontal”, “top”, “bottom”, “inner”, and “outer” is based on the orientation or positional relationship shown in the accompanying drawings. These terms are used only for ease of describing the present invention and simplifying the description, and do not indicate or imply that the referred device or element must have a specific orientation or be constructed and operated in a specific orientation. Therefore, they should not be construed as limiting the present invention.

Furthermore, the terms “first” and “second” are used for descriptive purposes only and should not be construed as indicating or implying relative importance or implicitly specifying the quantity of the indicated technical features. Thus, features defined as “first” or “second” may explicitly or implicitly include one or more of such features. In the description of the present invention, “multiple” means two or more unless explicitly specified otherwise.

### Embodiment 1

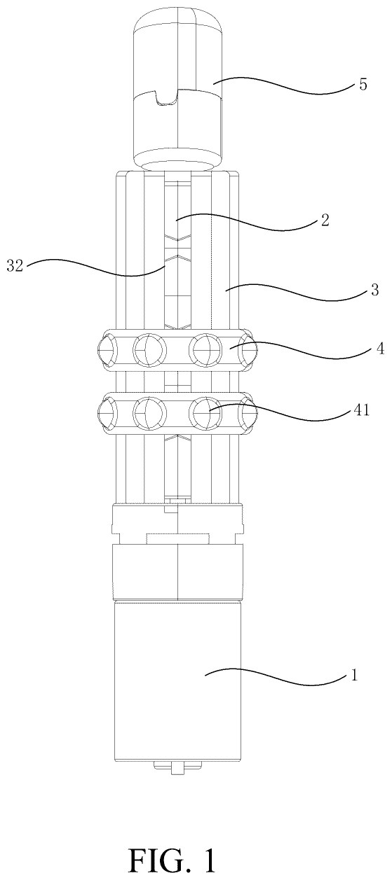

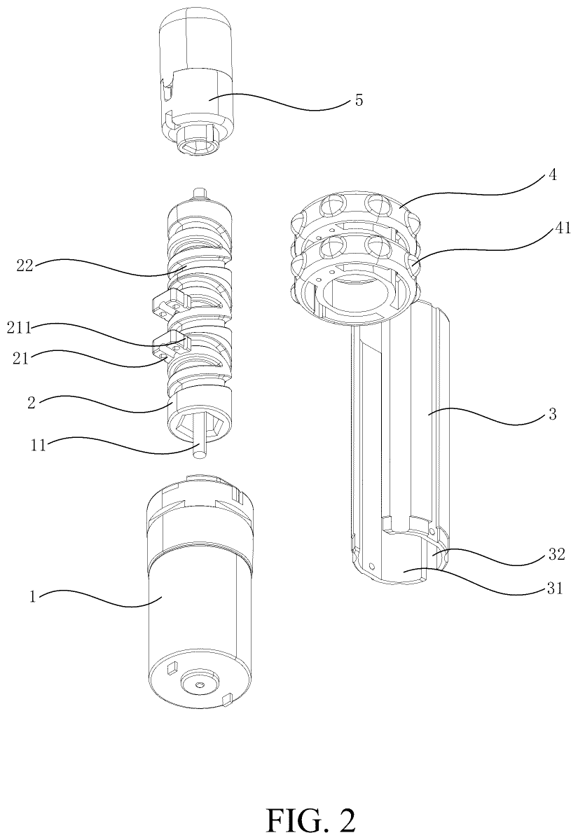

Please refer to FIGS. 1 to 2. Embodiment 1 of the present invention provides a sliding massage device for a massager. The sliding massage device includes a drive motor 1, a drive shaft 11 fixedly connected to the output shaft of the drive motor 1, a rotating frame 2 sleeved on the surface of the drive shaft 11 and fixedly connected to the drive shaft 11, a support housing 3 sleeved on the periphery of the rotating frame 2 and rotatably connected to the drive shaft 11, and a sliding ring 4 sleeved on the support housing 3 and slidably connected to the rotating frame 2. The rotating frame 2 is slidably provided with a sliding block 21 fixedly connected to the sliding ring 4, and the surface of the rotating frame 2 is recessed inward to form a drive guide rail 22 for slidably connecting the sliding block 21. The support housing 3 has a receiving cavity 31 for accommodating the rotating frame 2, and the support housing 3 is penetrated with a limiting guide rail 32 that allows the sliding block 21 to extend outside the receiving cavity 31. The side of the support housing 3 opposite to the side facing the drive motor 1 is provided with a vibration assembly 5. When the rotating frame 2 rotates, the sliding block 21 slides along the drive guide rail 22 and drives the sliding ring 4 to move up and down relative to the support housing 3. The drive motor 1 provides the kinetic energy required for the operation of the sliding massage device. When the drive motor 1 starts operating, the output shaft of the drive motor 1 transmits kinetic energy to the drive shaft 11, causing the drive shaft 11 to rotate. The rotation of the drive shaft 11 drives the rotating frame 2, which is fixedly connected to the drive shaft 11, to rotate. Since the support housing 3 encloses the rotating frame 2 within the receiving cavity 31, and the support housing 3 is rotatably connected to the drive shaft 11 while being fixedly connected to the drive motor 1, the sliding block 21, which is slidably arranged on the rotating frame 2, penetrates the limiting guide rail 32 on the support housing 3 and is fixedly connected to the sliding ring 4. As the rotating frame 2 rotates, the sliding block 21, under the limiting effect of the limiting guide rail 32, slides along the drive guide rail 22 relative to the rotating frame 2 and moves up and down repeatedly relative to the support housing 3. This drives the sliding ring 4, which is sleeved on the support housing 3 and fixedly connected to the sliding block 21, to move up and down repeatedly relative to the support housing 3. The vibration assembly 5 installed on the support housing 3 generates vibrations, enabling massage for the user. At the same time, the support housing 3 provides protective functions, preventing damage to the sliding massage device from compression during transportation and use. It also ensures a more rigid and flat overall structure of the massager, avoiding localized depressions during the up-and-down movement of the sliding ring 4 relative to the drive motor 1, thereby improving user comfort. On the premise of ensuring the comfort of users, the sliding massage device can bring more diversified massage methods to users, meet their use needs and bring better use experience to users.

Optionally, the opposite side surfaces of the sliding block 21 are inwardly recessed to form limit grooves 211 for accommodating the side walls of the support housing 3 located on both sides of the limit guide rail 32. By inserting the side walls of the support housing 3 on both sides of the limit guide rail 32 into the limit grooves 211 on the sliding block 21, the movement direction of the sliding block 21 is more effectively restricted, allowing the sliding block 21 to move more stably along a preset trajectory relative to the support housing 3. This makes the sliding ring 4 more stable during sliding, improving the structural stability and reliability of the sliding massage device and providing users with a better experience.

Optionally, there are multiple sliding rings 4, which are spaced apart and sleeved on the support housing 3 and slidably connected to the rotating frame 2. By arranging multiple sliding rings 4 spaced apart on the support housing 3 and using the sliding block 21 on the rotating frame 2 to drive them to slide relative to the support housing 3, users can receive stimulation from more massage points simultaneously. This ensures user comfort while providing a more intense massage effect, meeting user needs and offering a better user experience.

Optionally, the outer surface of the sliding ring (4) is uniformly provided with multiple massage protrusions (41); by arranging multiple massage protrusions (41) on the outer surface of the sliding ring (4), when the sliding ring (4) moves relative to the drive motor (1), the smaller contact area between the massage protrusions (41) and the target massage area allows greater pressure to be exerted on the massage region with the same applied force; this enables the massage protrusions (41) on the sliding ring (4) to deliver more intense stimulation to the user's target areas; while maintaining user comfort, this design provides stronger massage effects to meet user needs and enhance the overall experience.

Optionally, the vibration assembly 5 includes a mounting housing fixedly connected to the support housing 3 and a vibration motor disposed within the mounting housing. By placing the vibration motor inside the mounting housing, the vibrations generated by the vibration motor are transmitted to the mounting housing, which then transmits the vibrations to the outside. This ensures user comfort while protecting the vibration motor during transportation or use, helping to extend the service life of the massager.

### Embodiment 2

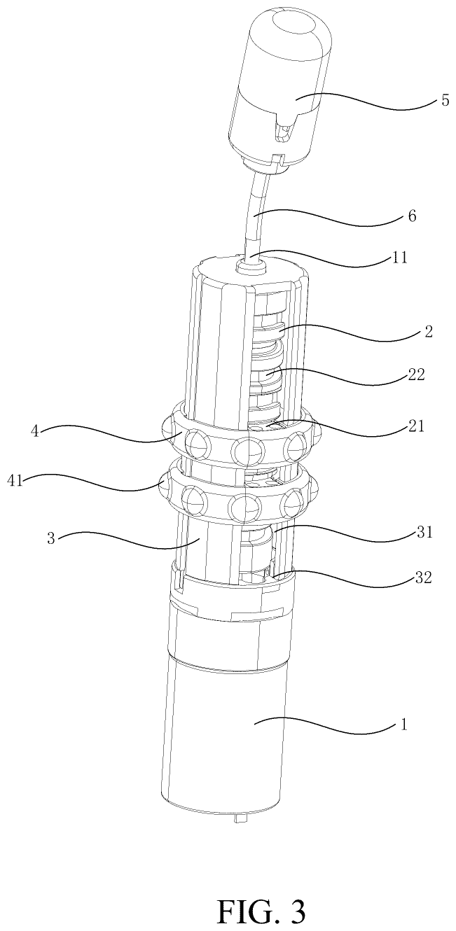

Please refer to FIG. 3. Embodiment 2 of the present invention provides a sliding massage device, further comprising a bent rotating shaft 6, one end of which is fixedly connected to the drive shaft 11 and the other end is fixedly connected to the vibration assembly 5. When the drive motor 1 starts operating, the drive shaft 11 rotates with the rotation of the output shaft. The drive shaft 11 rotates and drives the rotating frame 2 fixedly connected to it to rotate. When the rotating frame 2 rotates, the sliding block 21, under the limiting effect of the limit guide rail 32, slides relative to the rotating frame 2 along the drive guide rail 22 and repeatedly moves up and down relative to the support housing 3, thereby driving the sliding ring 4 sleeved on the support housing 3 and fixedly connected to the sliding block 21 to repeatedly move up and down relative to the support housing 3. At the same time, since the bent rotating shaft 6 is fixedly connected to the drive shaft 11, the bent rotating shaft 6 rotates with the rotation of the drive shaft 11, thereby driving the vibration assembly 5 fixedly connected to the bent rotating shaft 6 to rotate and oscillate. This allows the mounting housing to not only vibrate under the drive of the vibration motor but also rotate and oscillate under the drive of the bent rotating shaft 6. While ensuring user comfort, it can provide users with more diversified massage methods, meet user needs, and provide a better user experience.

### Embodiment 3

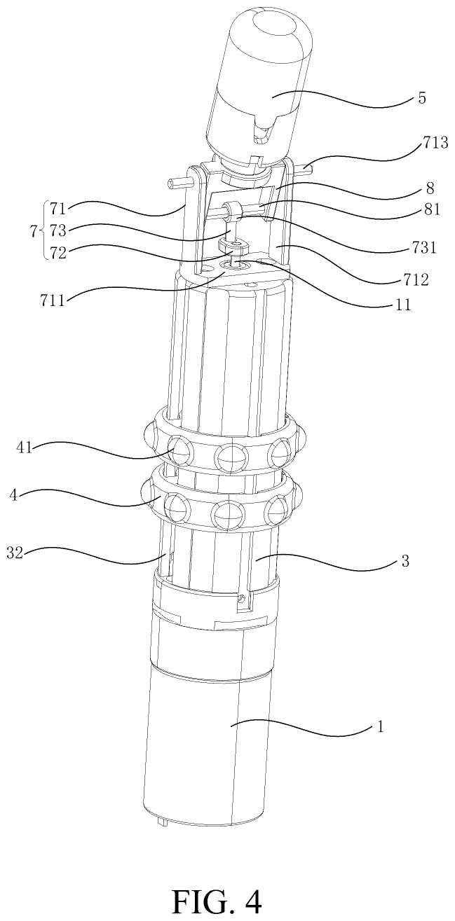

Please refer to FIG. 4. Embodiment 3 of the present invention provides a sliding massage device, further comprising an eccentric transmission assembly 7 and an activity assembly disposed between the support housing 3 and the vibration assembly 5. The drive motor 1 provides the kinetic energy required for the operation of the sliding massage device, and the eccentric transmission assembly 7 transmits the kinetic energy to the activity assembly, which is fixedly connected to the vibration assembly 5, causing the vibration assembly 5 to oscillate and achieve massage on the target area. The eccentric transmission assembly 7 includes a support frame 71 fixedly connected to the support housing 3, an eccentric wheel 72 fixedly connected to the drive shaft 11, and a transmission rod 73 fixedly connected to the eccentric wheel 72. The movable assembly includes a movable frame 8 rotatably mounted on the support frame 71 and a swing arm disposed on the movable frame 8. The transmission rod 73 is slidably connected to the movable frame 8, and the swing arm is fixedly connected to the vibration assembly 5. By connecting the drive shaft 11 and the transmission rod 73 through the eccentric wheel 72, the connection point between the transmission rod 73 and the eccentric wheel 72 is offset from the connection point between the drive shaft 11 and the eccentric wheel 72. At the same time, the movable frame 8 of the movable assembly is rotatably connected to the support frame 71, and the transmission rod 73 is slidably connected to the movable frame 8. When drive motor 1 is activated, drive shaft 11 drives eccentric wheel 72 to rotate, causing the connection point between transmission rod 73 and eccentric wheel 72 to pivot relative to support frame 71 with drive shaft 11 as the rotation center; simultaneously, transmission rod 73 transfers the kinetic energy from drive motor 1 to moving frame 8, allowing the connection point between transmission rod 73 and moving frame 8 to slide relative to moving frame 8 while driving moving frame 8 to pivot relative to support frame 71 with their connection point as the rotation center; this reciprocating motion of the swing arm induces oscillation in vibration assembly 5, enabling its mounting housing to not only vibrate under the drive of the vibration motor but also swing through the combined action of eccentric transmission assembly 7 and the moving assembly; while ensuring user comfort, this mechanism delivers diversified massage patterns to meet user needs and enhance the overall experience.

Optionally, the support frame 71 includes a support base 711 fixedly connected to the support housing 3, two support arms 712 disposed on opposite sides of the support base 711, and a connecting shaft 713 connecting the two support arms 712. Both support arms 712 are penetrated with first fixing holes for installing the connecting shaft 713, and the moving frame 8 is penetrated with a second fixing hole for the connecting shaft 713 to pass through. The support frame 71 is fixedly connected to a preset position of the support housing 3 through the support base 711, and the connecting shaft 713 is fixedly connected through the support arms 712 on opposite sides of the support base 711. The connecting shaft 713 passes through the second fixing hole of the moving frame 8, and both ends of the connecting shaft 713 are respectively fixed in the first fixing holes of the support arms 712 on both sides. This allows the moving frame 8 to rotate relative to the support frame 71 with the connecting shaft 713 as the rotation center under external force, thereby causing the swing arm mounted on the moving frame 8 to repeatedly move and making the vibration assembly 5 oscillate.

Optionally, one end of the transmission rod 73 is provided with a fixed part fixedly connected to the eccentric wheel 72, and the other end is provided with a sliding part 731 slidably connected to the moving frame 8. The transmission rod 73 is securely connected to the eccentric wheel 72 through the fixed part, with the connection point between the fixed part and the eccentric wheel 72 offset from the connection point between the drive shaft 11 and the eccentric wheel 72. The transmission rod 73 is slidably connected to the moving frame 8 through the sliding part 731, and the moving frame 8 is rotatably mounted on the support frame 71. When the drive motor 1 is activated, the drive shaft 11 drives the eccentric wheel 72 to rotate, causing the fixed part of the transmission rod 73 to rotate relative to the support frame 71 with the drive shaft 11 as the rotation center. Meanwhile, the transmission rod 73 transmits the kinetic energy output by the drive motor 1 to the moving frame 8, causing the sliding part 731 of the transmission rod 73 to slide relative to the moving frame 8 and drive the moving frame 8 to rotate relative to the support frame 71 with the connecting shaft 713 as the rotation center, thereby causing the swing arm to repeatedly move and making the vibration assembly 5 oscillate. The connection method between the fixed part and the eccentric wheel 72 is not limited here and may be detachable or non-detachable. The moving frame 8 is provided with a slide rail 81 for slidably connecting with the transmission rod 73. The sliding part 731 is penetrated with a connection hole for the slide rail 81 to pass through. The sliding part 731 of the transmission rod 73 is slidably disposed on the slide rail 81, allowing the sliding part 731 to slide relative to the moving frame 8 on the slide rail 81 and drive the moving frame 8 to rotate relative to the support frame 71, thereby causing the swing arm to repeatedly swing and making the vibration assembly 5 oscillate.

### Embodiment 4

Please refer to FIGS. 1 to 4. Embodiment 4 of the present invention provides a massager comprising a silicone soft shell with an inner cavity and the aforementioned sliding massage device disposed within the silicone soft shell. By covering the outer surface of the sliding massage device with a silicone soft shell, the massager's surface becomes softer and more stretchable, enhancing user comfort during operation; additionally, the shell provides waterproofing, facilitating easier use and cleaning while extending the device's lifespan. The sliding massage device derives its kinetic energy from drive motor 1; when activated, the motor's output shaft transmits power to drive shaft 11, inducing rotation that subsequently drives rotating frame 2, which is fixed to the shaft. Support housing 3 encloses rotating frame 2 within accommodation cavity 31 while maintaining a rotatable connection with drive shaft 11 and a fixed connection with drive motor 1; simultaneously, sliding block 21, mounted on rotating frame 2, extends through limit guide rail 32 on support housing 3 and attaches to sliding ring 4. As rotating frame 2 turns, sliding block 21, constrained by limit guide rail 32, slides along drive guide rail 22 relative to the frame while executing repeated vertical motion against support housing 3; this movement drives sliding ring 4, fixed to the block and encircling the housing, to oscillate vertically, working in tandem with vibration assembly 5 on the housing to deliver massaging vibrations. Support housing 3 also serves a protective role, shielding the sliding mechanism from compression damage during transit or use while maintaining structural rigidity; this prevents localized deformation of the silicone shell during sliding ring 4's vertical travel, further optimizing comfort. The device thus delivers diverse massage modalities without compromising comfort, meeting varied user needs for an enhanced experience.

The above descriptions are merely preferred embodiments of this embodiment and are not intended to limit it. Any modifications, equivalent replacements, and improvements made within the spirit and principles of this embodiment shall be included within the protection scope of this embodiment.

What is claimed is:

1. A sliding massage device for a massager, characterized by comprising: a drive motor, a drive shaft fixedly connected to an output shaft of the drive motor, a rotating frame sleeved on and fixedly connected to the drive shaft, a support housing sleeved around the rotating frame and rotatably connected to the drive shaft, and a sliding ring sleeved on the support housing and slidably connected to the rotating frame; wherein the rotating frame is provided with a sliding block slidably disposed thereon and fixedly connected to the sliding ring, and the surface of the rotating frame is recessed inward to form a drive guide rail for slidably connecting the sliding block; the support housing has a receiving cavity for accommodating the rotating frame, and is provided with a limit guide rail penetrating therethrough to allow the sliding block to extend outside the receiving cavity, and a vibration assembly is disposed on a side of the support housing opposite to the drive motor side; when the rotating frame rotates, the sliding block slides along the drive guide rail and drives the sliding ring to move vertically relative to the support housing.

2. The sliding massage device according to claim 1, characterized in that the opposite side surfaces of the sliding block are inwardly recessed to form limit grooves for accommodating the side walls of the support housing located on both sides of the limit guide rail.

3. The sliding massage device according to claim 1, characterized in that there are multiple sliding rings, which are spaced apart and sleeved on the support housing and slidably connected to the rotating frame.

4. The sliding massage device according to claim 1, characterized in that the outer surface of the sliding ring is uniformly provided with multiple massage protrusions.

5. The sliding massage device according to claim 1, characterized in that the vibration assembly includes a mounting housing fixedly connected to the support housing and a vibration motor disposed within the mounting housing.

6. The sliding massage device according to claim 1, characterized in that the sliding massage device further includes a bent rotating shaft, one end of which is fixedly connected to the drive shaft and the other end is fixedly connected to the vibration assembly.

7. The sliding massage device according to claim 1, characterized in that: the sliding massage device further comprises an eccentric transmission assembly and a movable assembly disposed between the support housing and the vibration assembly; the eccentric transmission assembly comprises a support frame fixedly connected to the support housing, an eccentric wheel fixedly connected to the drive shaft, and a transmission rod fixedly connected to the eccentric wheel; the movable assembly comprises a movable frame rotatably mounted on the support frame and a swing arm disposed on the movable frame; the transmission rod is slidably connected to the movable frame, and the swing arm is fixedly connected to the vibration assembly.

8. The sliding massage device according to claim 7, characterized in that one end of the transmission rod is provided with a fixed part fixedly connected to the eccentric wheel, and the other end is provided with a sliding part slidably connected to the moving frame, wherein the moving frame is provided with a slide rail for slidably connecting with the transmission rod, and the sliding part is penetrated with a connection hole through which the slide rail passes.

9. The sliding massage device according to claim 7, characterized in that the support frame includes a support base fixedly connected to the support housing, two support arms disposed on opposite sides of the support base, and a connecting shaft connecting the two support arms, wherein both support arms are penetrated with first fixing holes for installing the connecting shaft, and the moving frame is penetrated with a second fixing hole for the connecting shaft to pass through.

10. A massager, characterized by comprising a silicone soft shell with an inner cavity and the sliding massage device according to claim 1 disposed within the silicone soft shell.
